(19) United States
(12) Patent Application Publication
(10) Pub. No.: US 2026/0301404 A1
(43) Pub. Date: Oct. 1, 2026

(54) INTEGRATED SECURITY SYSTEM WITH LOW-BANDWIDTH VIDEO VERIFICATION

(71) Applicant: Resolution Products, LLC, St. Paul, MN (US)

(72) Inventors: Petre Tzvetkov, Sofia (BG); Dobrin Nedev, Sofia (BG); David J. Mayne, Eagan, MN (US)

(21) Appl. No.: 19/634,862

(22) Filed: Mar. 31, 2026

Related U.S. Application Data
(60) Provisional application No. 63/781,762, filed on Apr. 1, 2025.

(51) Int. Cl. G06V 20/40; G06V 20/52; G06V 20/70

(52) U.S. Cl. CPC G06V 20/44; G06V 20/52; G06V 20/70

(57) ABSTRACT

Disclosed herein are techniques, systems, and methods for edge video verification. A system can include: a security cloud server and a video verification device. The video verification device can be configured to communicate with the security cloud server via one or more networks and further can be configured to perform operations that may include: receiving video data from peripheral devices on a premises, processing the video data on the edge to generate event information, and returning the event information to the security cloud server over the one or more networks. The peripheral devices can include video cameras. The video data can be received from the peripheral devices over another network that is different than the one or more networks. Processing the video data on the edge can include applying artificial intelligence (AI) techniques to the video data.

### CROSS REFERENCE TO RELATED APPLICATIONS

This application claims the priority benefit of U.S. Provisional Patent Application No. 63/781,762, filed Apr. 1, 2025, the entirety of which is incorporated herein by reference.

### TECHNICAL FIELD

This disclosure generally describes devices, systems, and methods related to home security.

### BACKGROUND

Home security systems have included a control panel that manages communications with devices, such as door and window sensors, locks, alarms, lighting, motion detectors, security cameras, etc., throughout the house using particular communication protocols. The control panel may communicate with one or more remote devices or central stations using particular communication protocols.

Home automation is building automation for a home, called a smart home or smart house. A home automation system will control lighting, climate, entertainment systems, and appliances. It may also include home security such as access control and alarm systems. Devices in such home automation can be connected with the Internet. For example, a home automation system may connect controlled devices to a central hub or gateway. The user interface for control of the system uses either wall-mounted terminals, tablet or desktop computers, a mobile phone application, or a Web interface, that may also be accessible off-site through the Internet.

For a variety of reasons, it is often desirable to upgrade an existing security system to include additional or different forms of protection. This may be the case if, for example, a facility (for example, a home, commercial facility, etc.) has expanded in size, the system in place has some features that are undesirable for the facility owner or operator, or the facility owner or operator wishes to have a different monitoring company in charge of the facility (for example, a monitoring company that charges a lower monthly fee), and that monitoring company requires a particular system control device with which to communicate. In such a case, it may be desirable to switch the existing system control device to a control device that has some advantage that is valuable to the facility owner or operator. However, an existing system control device and a new control device may be only able to detect and receive transmissions from sensors that have particular data packet protocols and definitional parameters that are specifically designed to work with the existing system control device and the new control device, respectively. That said, it is also not desirable to have to discard entirely an entire existing security system simply to migrate to a different system control device.

### SUMMARY

The disclosure generally describes technology for low-bandwidth video verification systems for intrusion detection using cameras or other sensors and dual network connectivity. For example, the disclosed technology can provide intrusion detection and alarm verification in physical security systems, and more specifically to a hybrid local/cloud system that can be configured to capture and transmit pre-and post-alarm video from various different types of cameras and/or sensors using dual-path network architecture optimized for low-bandwidth transmission. The disclosed technology can implement standards-based local video integration. A video verification device can be configured to capture video data from a broad range of cameras, such as open network video interface forum (ONVIF)-enabled cameras and/or real-time streaming protocol (RTSP)-enabled cameras by joining a same local network, thereby enabling flexible deployment without said integrations. The disclosed technology can also provide for independent wide area network (WAN)-based video delivery with network segmentation. The video verification device can be configured to deliver video content using a low-bandwidth cellular connection, allowing deployment on isolated or secure local networks and providing a resilient delivery path even if broadband connectivity is lost. This architecture can allow for cameras and other intrusion devices in a security system to be on a segmented network without remote access, thereby minimizing risk of cyberattacks while still maintaining an ability to deliver intrusion and video content to relevant parties, such as monitoring centers and/or emergency response teams. The video content, as described herein, can be processed by the local video verification device using edge processing techniques, and further formatted to be transmitted over a low cost, low power cellular network such as, category M (CAT-M) cellular networks that are designed for Internet of Things (IoT) devices. In some implementations, the video content can be transmitted over other networks having other costs and/or power (e.g., high cost or high power cellular networks). The on-edge processing techniques can include performing edge artificial intelligence (AI) tasks, such as motion detection and/or object classification, to enable annotating and contextualizing video data for delivery, thereby enhancing situational awareness for relevant users, such as monitoring personnel and/or emergency response teams. Moreover, the disclosed technology can provide unified intrusion and video event packaging via security panel integration. The described video verification device can be configured to interface with alarm systems through keybus and/or signal monitoring to synchronize intrusion signals with captured video, thereby producing a unified event record before cloud delivery.

One or more embodiments described herein can include a system for edge video verification, the system including a security cloud server and a video verification device that can be configured to communicate with the security cloud server via one or more networks and further can be configured to perform operations that may include: receiving video data from peripheral devices on a premises, processing the video data on the edge to generate event information, and returning the event information to the security cloud server over the one or more networks.

In some implementations, the embodiments described herein can optionally include one or more of the following features. For example, the peripheral devices can include video cameras. The one or more networks can include low cost, low power cellular networks. The video data can be received from the peripheral devices over another network, the another network being different than the one or more networks. The system further can include a gateway that can be configured to communicate with the security cloud server and the video verification device via the one or more networks, the gateway device being configured to be connected to an existing security panel at the premises. Sometimes, the video verification device can be part of the gateway.

In some implementations, processing the video data on the edge can include applying artificial intelligence (AI) techniques to the video data. The AI techniques could have been trained to tag the video data with alarm states and alarm statuses. The AI techniques could have been trained to encode one or more flags to the video data that may correspond to at least one of detected activities, events, objects, and movements in the video data. The AI techniques could have been trained to annotate the video data based on detecting at least one of activities, events, objects, and movements in the video data. The AI techniques could have been trained to generate metadata for the video data based on detecting at least one of activities, events, objects, and movements in the video data. Sometimes, processing the video data on the edge to generate the event information further may include associating the video data to a security event. The security event can include at least one of an intrusion on the premises, a fire at the premises, and smoke at the premises.

The devices, system, and techniques described herein may provide one or more of the following advantages. For example, the disclosed technology provides for improving operations, use of compute resources, and processing efficiency in security systems. Existing systems, such as existing video verification systems, can rely on broadband connections and proprietary camera hardware, which can be costly, power-hungry, and vulnerable to network outages. With increased demand for verified alarm events prior to emergency dispatch, there is a need for a system that supports various different types of cameras and/or sensors, such as industry-standard cameras, and that operates independently of local broadband infrastructure to provide intelligent video context, all while maintaining low power and bandwidth requirements. The disclosed technology therefore provides improvements to the existing systems by integrating said systems with industry-standard cameras, other sensors, and intrusion panels to capture, analyze, and transmit alarm-related video content. The disclosed technology can operate on local networks to access camera feeds and uses a cellular WAN or other network connection to deliver relevant video data, annotations, and/or metadata to a security cloud server, even in the absence of local internet connectivity. The disclosed technology can further leverage on-device (e.g., edge) artificial intelligence (AI) processing to contextualize events, alarm states, alarm statuses and reduce false alarms, thereby enabling more efficient and accurate emergency response than the existing systems.

Moreover, the disclosed technology can include a gateway or security communicator device that is connectable to an existing security platform (e.g., a legacy security panel or keypad) and can further connect to other security and home automation devices which are not compatible with the existing security platform, thereby integrating all the home security and automation devices. The gateway can provide a centralized point of controlling all existing and new security and automation devices at a premise, and allow flexibility in modifying and expanding a security system at the premise without need of replacing the security system that has been already installed throughout the premise. In some implementations, a video verification device can be part of the gateway, which can provide for edge-based processing of signals from the home security and automation devices.

As another example, the disclosed technology can permit for multiple different pathways to be selectively chosen to route data streams among different devices, such as from security and automation devices to output devices, thereby ensuring continuous data transmission between devices in reliable and cost-efficient manners and while reducing potential risks of cyberattacks.

The disclosed technology provides for deployment of complex and uniquely trained AI (or other machine learning) on the edge that reduces processing time and improves consumption of available resources to generate contextualized video content for relevant users. Such training and subsequent deployment of the AI cannot be reasonably performed in the human mind, including but not limited to specific operations that the AI is trained to perform, the iterative and real-time execution of the AI on the edge to generate reliable and accurate information, and the receipt and processing of disparate types of data all in real-time or near real-time on the edge. The disclosed technology provides efficient AI training and deployment that does not require human intervention or input, which makes it impossible for this technology to be reasonably performed in the human mind. The model(s) can be iteratively executed during runtime and simultaneously updated to generate reliable and accurate outputs, functions that also cannot be reasonably performed in the human mind.

After the disclosed technology generates contextualized video content from processing signals from existing sensors, cameras, and/or security systems, the disclosed technology can display relevant information and data using a GUI on a display of user/computing devices of the relevant users in a unique and easy way to understand format. The existing systems may not provide the disclosed solutions for at least the following reasons: (i) the significant processing power required for to process such vast amounts of information and generate contextualized video content, (ii) the considerable data storage requirements for maintaining information collected and determined by the disclosed technology, (iii) algorithms, AI, and/or other machine learning techniques that allow for the automated processing and contextualizing of disparate signals based on additional data that can be retrieved during runtime, and/or (iv) other hardware and software features described herein.

In addition, the GUI displays results of the execution of these complex algorithms, AI, and/or machine learning techniques in a manner that can be easily understandable by a human user. The information can be processed for presentation on small or handheld screens, which can improve operation of computing devices, etc. Additionally, translation of outcomes from these complex algorithms, AI, and/or machine learning techniques through the GUI onto video or other information displayed for a user can improve comprehension of considerable quantities of highly processed data. For example, an exemplary algorithm from this complex collection of algorithms can require: receiving data from many different sources, cleansing the data, selecting some data, ignoring some of the data, performing multiple processes on a selected subset of the data, combining the data from these multiple processes, and then outputting that data within a short amount of time (e.g., less than a minute), all for multiple relevant users to view in GUIs. The use of AI techniques described herein can improve the functioning of the user devices to improve their consumption and use of resources in presenting relevant information to the user in a user-friendly manner.

Moreover, the existing security systems exhibit technical problems in that they do not provide fast, efficient, and automated video processing to glean context and other relevant information on the edge. The disclosed technology provides technical solutions to such technical problems. For example, the disclosed technology provides real-time analysis and processing of many different signals, including video data, in real-time on the edge at a video verification device and/or gateway that hosts the video verification device. Edge processing provides lightweight, accurate, and fast results with available compute resources, thereby allowing for relevant and accurate results in real-time, or near real-time. Moreover, deploying AI techniques at the edge further allows for relevant, contextualized information about a security event, alarm, or other type of event to be generated in real-time and on the fly, even when network communications are weak or nonexistent. This technical solution allows for the contextualized video content to be determined regardless of any networking interruptions, which is not realized by the existing systems that lack lightweight edge deployment of AI techniques to process the signals, including the video data. Similarly, the disclosed technology may not be reasonably performed in the human mind, as the human mind is incapable of continuously receiving and processing hundreds to thousands of signals, including continuous video feeds, analyzing those signals with AI techniques, and then generating relevant output including annotations, context, video modifications, and/or metadata to assist in understanding any type of security event, alert, or other type of event that may be detected.

The details of one or more implementations are set forth in the accompanying drawings and the description below. Other features and advantages will be apparent from the description and drawings, and from the claims.

### BRIEF DESCRIPTION OF THE DRAWINGS

FIG. 1A illustrates an example system for integrated home security and automation services with a video verification device.

FIG. 1B illustrates another example system for integrated home security and automation services with a video verification device.

FIG. 1C illustrates an example connection between a control panel and a gateway or security communicator device.

FIG. 2 is a diagram of an example environment that can implement the system of FIGS. 1A, 1B, and/or 1C.

FIG. 3 is a conceptual diagram of a system for processing signals, such as video data, on the edge at a video verification device.

FIG. 4 is a diagram of an example gateway, or security communicator device, that can be configured to provide an integrated home security and automation service with a video verification device.

FIG. 5 is a diagram of an example video verification device described herein.

FIG. 6 is a flowchart of a process for processing signals, such as video data, on the edge with AI techniques.

FIG. 7 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to low-bandwidth video verification using one or more different types of cameras in an environment and dual network connectivity. The disclosed technology can be used with existing or new security systems to provide for edge-based processing of video feeds, video streams, and/or other signals to generate contextualized, relevant data associated with security events (e.g., intrusion detection) and/or other states and/or statuses in the environment. The edge-based processing can be performed using edge AI. Information that results from performing the edge-based processing can then be transmitted, via a secure connection such as a low-bandwidth cellular connection, to a remote system, such as a security cloud server, monitoring system, and/or other systems associated with emergency responders.

A home security system provides a centralized point of controlling existing and new security and automation devices at a premise (e.g., houses, buildings, or other facilities). The system can include at least three subsystems: an existing local security platform, a gateway or other security communicator device (e.g., a security panel and/or user controller(s)), and a security cloud server. The gateway can include a security panel that can be installed in a premise and connected to the existing local security platform in the premise. The security panel can come with one or more user controllers (e.g., touchpads) that provide an integrated user interface for a user to manage and control all security and automation devices in one place. The security panel is operated to tap a data bus of the existing local security platform to obtain security data from the platform. Further, the security panel can receive data from the other security and automation devices at the premise, including but not limited to sensors, such as cameras or other imaging devices. The security data from the existing local security platform and the data from the other security and automation devices can be used to provide integrated home security and automation management. The security panel can be connected to the security cloud server selectively through one of multiple communication interfaces (e.g., selectively using one of multiple connection options, such as Ethernet, Wi-Fi, and cellular) so that the security panel remains connected to the security cloud server at all times and provides seamless security and automation services.

The gateway can at least partially self-program to communicate with an existing local security panel when the gateway is connected to the existing panel. When an installer connects a gateway to an existing panel at the premise, the gateway can automatically detect hardware connections with and signals from the existing local security panel, and adapt itself to permit for communication with the existing local security panel to take over at least partially the features and functionalities of the existing local security panel. Some embodiments of the home security system can operate to blend information from an existing local security platform (e.g., a legacy system or legacy system alarms) with other inputs from sensors and devices that are added to the home security system, and provide for integrated control of security and automation devices at premises where the existing local security platform is located. Further, the home security system can operate to select from among multiple different communication channels to establish communication between a gateway and a cloud computing system.

Some embodiments of the home security system can permit for security and automation devices (e.g., cameras, sensors, etc.) in the system to be remotely set up and configured through a security integration system, such as the gateway and/or the security cloud server, instead of being set up and configured directly through a communication network (e.g., a home router). Further, local changes to the communication network environment at a premises, such as changing internet providers and credentials, can be provisioned and updated on the security and automation devices through the security integration system at the premises.

Some embodiments of the home security system can selectively choose multiple routes for signals (e.g., data streams) from security and automation devices to different devices such as output devices. Further, some embodiments of the home security system can operate to select from among multiple different communication channels to establish communication between a security communicator device and a cloud computing system.

Some embodiments of the home security system include one or more computing devices with an integrated user interface for outputting security and automation information and receiving a user input of controlling the system. The user interface is configured to integrate outputs from the existing local security platform and outputs from the security communicator device and associated peripheral devices, and present a blend of information for the entire home security system, thereby providing for integrated view and control of security and automation devices at the premises.

Communicator devices, systems, and methods are described that can upgrade or “takeover” an existing home security system. Such devices, systems, and methods, can function to enhance an existing home security system with one or more home automation, alarm, and/or surveillance features. Various example embodiments include a triple alarm path capable of communicating across multiple communication paths (e.g., a single selected communication path or multiple communication paths in parallel), a unified dashboard for security, surveillance, and home automation features, the ability to add legacy systems over local and remote networks, the ability to view video over a home network connection, automatic failover of communication paths, encryption with sensors and other devices, the ability to configure local settings over cellular/mobile data network connection, the ability to add both panel monitored and/or cloud monitored sensors to these legacy systems, the ability to self-configure to the legacy (or new) security system (e.g., can be performed by sensing various hardware connections and signals and making responsive configurations to enable system functionality), the ability to select communication path priorities through preferences established in the network services platform, the ability to determine optimal communication path in the device based on factors including cost of data path, availability of data path, latency needs related to the sensor data or other sensor triggered criteria, the ability to automatically switch from cloud platform control to local control based on detection by one of the plurality of local WANs enabled by the BAT-Connect, and/or combinations thereof.

The gateway described herein may be connected efficiently and without requiring complex training. For example, joining the gateway to the keypad bus of an existing panel, the gateway can automatically detect the type/brand of panel and adapt to its specifications, if appropriate. The gateway may thus instantly join as a peripheral device, reducing technician setup time.

In various example embodiments, the gateway communicates with one or more video components (e.g., security cameras located at a premises). The gateway facilitates pairing of such home automation devices, intrusion and environmental sensors in a single, mobile experience. Real-time and intuitive controls may be enabled through mobile applications (e.g., based on Alula iOS, Android, etc.). Additionally processing of video data from the video components can be performed at the gateway, via a video verification device. The processing of the video data can additionally or alternatively be performed via a video verification device that is separate from the gateway but in network communication with the gateway.

The gateway and/or the video verification device may include various communication interfaces that facilitate broad compatibility, and that can extend the useful service life of legacy systems the gateway is connected with. For example, with IP connections on board (e.g., Ethernet and Wi-Fi), the gateway and/or the video verification device may be less hindered by cell sunsets or communication protocol obsolescence. Multiple communication interfaces also provide a backup connection that can promote robust and reliable communication. For example, with a backup connection always at the ready, the gateway and/or the video verification device facilitates constant connectivity. The connection is thus less dependent on a network with spotty or intermittent coverage, or that may become obsolete. Moreover, in some example embodiments, an auto-switch capability promotes a constant connection to cellular or IP communication paths (e.g., to always maintain alarm reporting).

In various example embodiments, the gateway and/or the video verification device includes three paths of WAN connectivity (e.g., from the single gateway and/or video verification device housing/frame). The gateway and/or the video verification device thus may link to a cloud service using Ethernet, Wi-Fi or CAT-M1 cellular communication paths. In an example embodiment, the gateway and/or the video verification device can be compatible with 5G communication. With CAT-M 1 IoT-optimized communications to access the cellular network, the gateway and/or the video verification device can be operational with the common and current 4G LTE networks, as well as the newest 5G cellular technology. Such flexibility in communication may further reduce exposure to cellular communication protocol obsolescence. The Wi-Fi communication interface may connect directly to a broadband router and/or create a Wi-Fi access point for a touchpad associated with the gateway and/or the video verification device.

In various example embodiments, the gateway and/or the video verification device described herein facilitates adoption of improved communication protocols, enhanced security, surveillance, and automation features, and reduced dependence on cellular carriers.

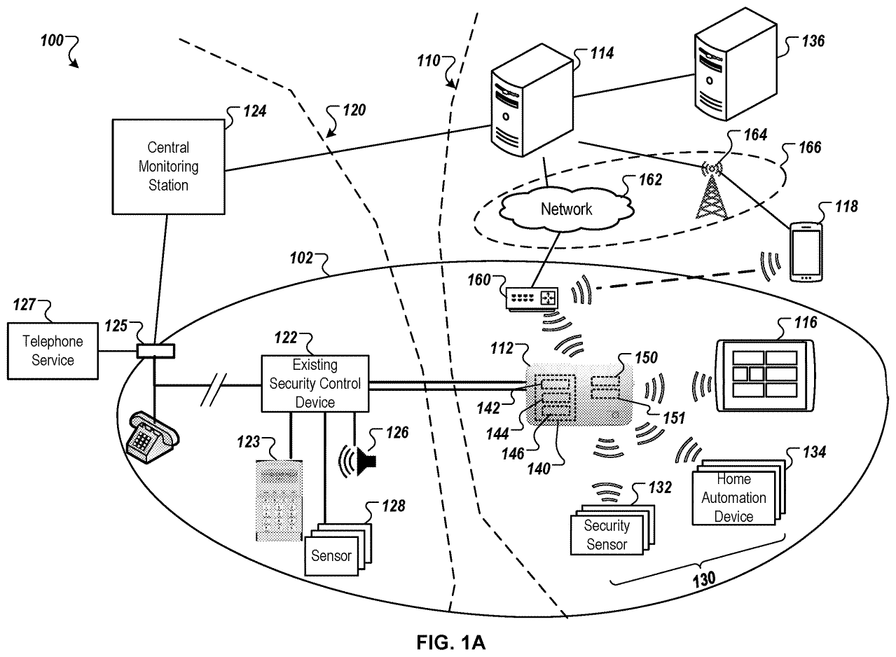

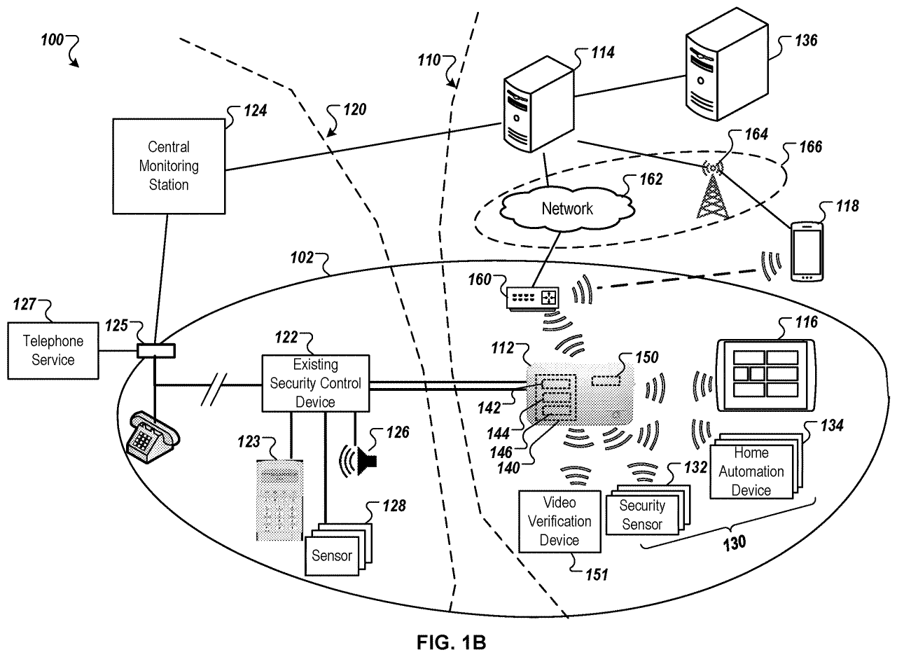

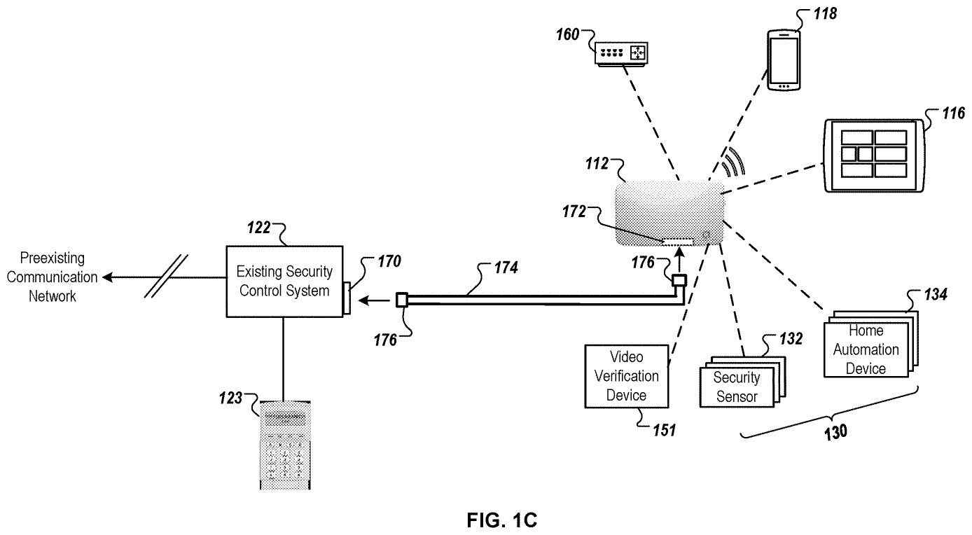

Referring to the figures, FIG. 1A illustrates an example system 100 for integrated home security and automation services with a video verification device 151. FIG. 1B illustrates another example of the system 100 for integrated home security and automation services with the video verification device 151. FIG. 1C illustrates an example connection 175 between the existing security control system 122 and the gateway 112.

Referring to FIGS. 1A, 1B, and 1C, the system 100 can include a security integration system 110 configured for connection with an existing security platform 120 and enhance the security platform 120 with additional features that may not be available from the security platform 120.

For example, the existing security platform 120 can be a legacy security platform that was previously installed and provided at a premise 102 before the security integration system 110 is employed, or other security platforms which may be installed before, when, or after the security integration system 110 is deployed and in operation at the premise 102. The existing security platform 120 may have limited functionalities and is not capable of providing flexibility in modifying and expanding a home security and automation environment at the premise 102. Examples of the existing security platform 120 include but are not limited to Honeywell Vista, DSC PowerSeries, Interlogix, Concord, NX, and Simon panels.

In some implementations, the existing security platform 120 includes an existing security control device 122, a control panel 123, and a central monitoring station 124. The existing security control device 122 can be installed in the premise 102 and connects to the control panel 123 configured to interact with a user to arm and disarm a home security system. The existing security control device 122 can include, or be connected to, a sound output device 126 (e.g., a siren, speaker, etc.) which can be activated to output an alarm sound when certain security events occur which generate an alarm signal. The existing security control device 122 can be housed in an enclosure and installed at a fixed location while the control panel 123 can be mounted at a fixed location and/or potable for easy programming and interaction for users. Alternatively, the existing security control device 122 may be configured to be portable. The existing security control device 122 can enable communication with an alarm company (e.g., the central monitoring station 124) that monitors the premise 102. The control panel 123 can be of various types. For example, the control panel 123 can include a keypad (with numeric and other buttons) to arm/disarm and otherwise maneuver a security system. The control panel 123 can include a touchpad, voice control, and/or wireless remotes (e.g., key fobs) for additional functionalities.

The existing security control device 122 provides an interface that communicatively connects the control panel 123 and the central monitoring station 124. The existing security control device 122 may be installed at a suitable location at the premise and connected to an existing communication network by using an existing network interface device, such as a telephone interface 125 connected to a telephone service 127 or other types of interfaces connected to cable and/or Internet services.

The central monitoring station 124 provides services to monitor a home security system, such as burglar, fire, and other residential or commercial alarm systems. The central monitoring station 124 may also provide watchman and supervisory services. The central monitoring station 124 can use telephone lines, mobile lines, and/or radio channels to connect to the existing security control device 122 and call appropriate authorities in the event an alarm signal is received.

The existing security platform 120 may include one or more sensors 128, such as door sensors, window sensors, motion sensors, imaging sensors (e.g., cameras), etc., which are connected to the existing security control device 122. The sensors 128 can detect predetermined events (e.g., open/closed doors and windows, motions detected, etc.), and generate and transmit sensor signals representative of such events to the existing security control device 122 and/or the central monitoring station 124. The sensors 128 can be directly controlled through a user interface (e.g., keypad, buttons, etc.) (e.g., the control panel 123) of the existing security control device 122.

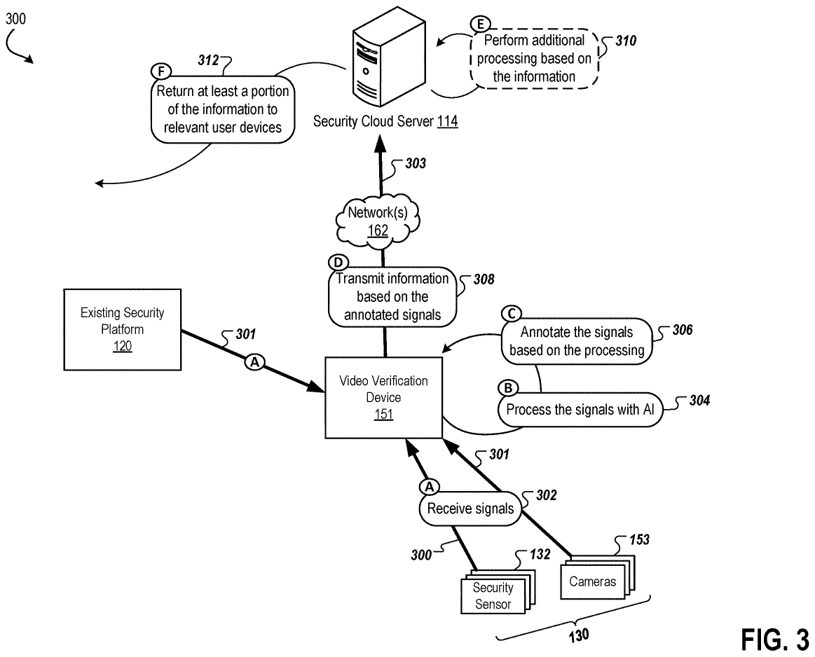

The security integration system 110 can include a gateway 112 (e.g., security communicator device) and a security cloud server 114. In addition, the security integration system 110 can include a user controller 116 and a mobile computing device 118. The gateway 112 can include a video verification device 151, as shown in FIG. 1A. The video verification device 151 can be configured to process video data from any of the sensors 128, security sensors 132, home automation devices 134, and/or other peripheral devices 130, including but not limited to cameras. In some implementations, as shown in FIG. 1B, the video verification device 151 can be separate from the gateway 112, but part of the security integration system 110. The video verification device 151 can be in network communication with other components of the security integration system 110 and/or the existing security platform 120 to provide the disclosed techniques. Refer to at least FIG. 3 for further discussion about operations performed by the video verification device 151.

The gateway 112 can be configured for connection with a legacy control panel (e.g., the existing security control device 122) to enhance the existing security platform 120 with additional features. For example, the existing security platform 120, which had been deployed at a premise for a while (e.g., years), have limited hardware and/or software capabilities to keep track on technology development up-to-date, and thus typically lack additional functionalities to support user demands. By way of example, a legacy security platform may include a control panel which is not capable of supporting Z-Wave home-automation, interactive services, IP connectivity, and/or cellular communications capabilities, and/or is incompatible with newer peripheral devices (e.g., one or more of the peripheral devices 130). As described herein, the gateway 112 can be configured to turn a conventional control panel into an integrated home security with broadband and cellular communication capabilities, and further combine the home security with home automation to provide smart home as a service platform.

Still referring to FIGS. 1A, 1B, and 1C, the gateway 112 can be configured to connect to the existing security control device 122 by, for example, wiring the gateway 112 to the existing security control device 122. In some implementations, the gateway 112 is configured to connect to one or more types of wired communication terminals 170 can be used to connect the gateway 112 to the existing security control device 122. Further, the gateway 112 can provide one or more types of connection terminals 172 for connection with the existing security control device 122. For example, a control panel can provide a data bus, telephone lines, and/or other suitable communication interfaces, and the security communicator device 112 can be connected to the control panel via any of the communication terminals 170 that is available from the control panel. In some implementations, a cable 174 is used to provide wired connection between the gateway 112 and the existing security control device 122. At least one end of the cable 174 can be provided with a connector 176 to be plugged into the terminals 170 and 172. Alternatively, the gateway 112 can be wirelessly connected to the existing security control device 122.

In some implementations, when the gateway 112 is connected to the existing security control device 122, the functionalities of the existing security control device 122 and/or other components in the existing security platform 120 can be disabled, limited and/or modified to ensure the operations of the gateway 112, the security cloud server 114, and/or other components in the security integration system 110 so that the entire security and automation components in the premise are fully integrated and centralized by the security integration system 110. In addition or alternatively, the existing security control device 122 can be disconnected from the existing communication network (e.g., telephone, cable, and/or Internet services).

As described herein, in an example embodiment, the gateway 112 is configured to be at least partially self-programming when connected to the existing security control device 122. For example, the gateway 112 can automatically detect a type of the existing security control device 122, or features and functionality of the existing security control device 122, when connected to the existing security control device 122. Automatic detection may facilitate installation with the existing security platform 120.

The gateway 112 can be connected to the security cloud server 114 using various communication protocols. The gateway 112 includes a plurality of communication interfaces 140. For example, the communication interfaces 140 include one or more broadband interfaces, such as a wired communication interface 142 (e.g., Ethernet) and a wireless communication interface 144 (e.g., Wi-Fi). In addition, the communication interfaces 140 can include a cellular communication interface 146 (e.g., 4G/LTE, CAT M1 for 5F transition, etc.). In addition or alternatively, the gateway 112 can include other wired or wireless communication interfaces. Thus, the gateway 112 is capable of providing multiple-path (e.g., triple-path) cloud connectivity. The gateway 112 can communicate security events (e.g., alarm) and/or home automation events, or other data, via one or more of the communication interfaces 140.

In some implementations, one or more cameras can be configured as battery-backed devices that are communicatively coupled directly to one or more machine-to-machine (M2M) access points, such as cellular access points. In this way, the cameras can maintain operation during power interruptions and/or local network outages. For example, when a primary communication path is unavailable, the cameras can transmit video data, event information, and/or associated metadata via the M2M access points over a cellular network, thereby maintaining video and event coverage. In some implementations, the cameras can dynamically adjust characteristics of transmitted video, including resolution and/or frame rate, based on available bandwidth, network conditions, and/or a type of client device requesting access to the video. For example, the cameras can provide lower-resolution video during constrained cellular transmission conditions and higher-definition video when bandwidth is sufficient or when higher-detail video is requested. As a result, the disclosed system can provide resilient video monitoring with adaptive video delivery across varying communication conditions.

The broadband interfaces of the gateway 112, such as the wired communication interface 142 and the wireless communication interface 144, can connect to a broadband router 160 which provides access to one or more networks 162. Broadband communications between the gateway 112 and the security cloud server 114 can be established via the network(s) 162 and the router 160 to which the gateway 112 is connected.

The communication interfaces 140 can be selected based on one or more factors, such as availability, quality, speed, cost of utilizing communication paths, and other requirements. In addition or alternatively, the priorities among the communication interfaces 140 of the gateway 112 can be determined through preferences established in a network services platform. By way of example, a cost may be considered to select the lowest-cost communication path (e.g., the wireless communication interface 144). Alternatively or additionally, a communication interface can be selected based on available bandwidth, such as where a particular communication path is unavailable, or for a communication having particular bandwidth requirements. In an example embodiment, the gateway 112 can automatically select a particular communication path, and/or switch between communication paths, promoting reliable and robust communication with the security cloud server 114 or other remote computing devices.

As illustrated in FIGS. 1A, 1B, and 1C, the gateway 112 can add one or more peripheral devices 130. Such peripheral devices 130 were not part of the existing security platform 120, and are to be integrated with the existing security platform 120 after the gateway 112 is connected to the existing security platform 120. The peripheral devices 130 being added may be incompatible with the existing security platform 120 if directly connected to the existing security platform 120, but can be integrated with the existing security platform 120 if connected through the gateway 112. The gateway 112 is configured to operate with such peripheral devices 130 such that the peripheral devices 130 can be used with the existing security platform 120 to enhance its functionalities. The peripheral devices 130 can be connected to the gateway 112 via one or more wired or wireless communication protocols, such as Wi-Fi, Bluetooth, etc., which can facilitate addition of the peripheral devices 130.

In some implementations, the peripheral devices 130 include security devices 132 and home automation devices 134. Examples of the security devices 132 include door and window sensors, automated locks, alarms, lighting, motion detectors, security cameras, glass break detectors, and other suitable security components. Surveillance cameras and motion sensors work hand in hand with allowing home owners to keep an eye on areas of their home that they might not have access to at the moment. Motion sensors create zones which cannot be accessed without sounding an alarm. In addition or alternatively, cameras can be set up to detect any movement and display it on the owner's account. Glass break detectors are usually installed near glass doors or a window front of a store. Some examples of glass break detectors can use a microphone to detect when a pane of glass is broken or shattered. By monitoring the sound and vibrations the alarm only reacts to sounds above a certain threshold to avoid false alarms.

Examples of the home automation devices 134 include thermostats, lights, garage door controllers, sensors, other suitable devices associated home appliances and electronic devices. The home automation devices 134 may include a heating, ventilation and air conditioning (HVAC) system which can be remotely controlled through the gateway 112. Further, the gateway 112 can be used as a lighting control system that permits for various lighting device inputs and outputs to communicate with each other and/or with a user interface. Moreover, the home automation devices 134 may include an occupancy-aware control system that can sense the occupancy of the home using, for example, smart meters and environmental sensors (e.g., CO2 sensors) which can be integrated into a home security system, and trigger automatic responses for energy efficiency and home comfort applications. Further, the home automation devices 134 may include leak detectors, smoke detectors, CO detectors, devices for tracking pets and babies' movements and controlling pet access rights, air quality monitors/controllers, smart kitchen appliances (e.g., coffee machines, ovens, fridge and multi cooker, etc.).

The cloud security server 114 can be configured to communicate with the gateway 112 via one or more communication networks 166, such as over one or more IP networks 162 (e.g., Ethernet, Wi-Fi, and/or other IP networks) and/or cellular networks 164 (e.g., 4G LTE, 5G IoT, and/or other cellular networks). The cloud security server 114 can provide various services related to the gateway 112, such as real-time and/or near real-time data and control access, multipath notification alternatives, multiple service enablement, and/or other suitable services. For example, the video verification device 151 can be configured to locally process signals such as video data from the peripheral devices 130, then transmit the processed signals and other relevant information to the server 114. Refer to at least FIG. 3 for further discussion about processing the signals by the video verification device 151 and communication between the device 151 and at least the server 151. As described herein, the services from the server 114 can be provided to a user across any of a variety of devices, such as the user controller 116 (e.g., a touchpad), the mobile computing device 118 (e.g., a smartphone or tablet), and/or other user devices. The services can be provided to such devices when they are local and/or remote from the premises where the gateway 112 is located.

In some implementations, the cloud security server 114 can communicates with a media analysis system 136 configured to process and/or analyze media data, such as image/video data, obtained from a peripheral device 130 (e.g., a surveillance camera or other image/video capturing devices). For example, such a peripheral device 130 can capture an image/video, and transmit it to the gateway 112, which then transmits it to the video verification device 151 for edge-based processing before transmitting the processed data to the security cloud server 114. If necessary, the security cloud server 114 can send the data to the media analysis system 136 for additional or other management, processing, and/or analysis. Alternatively or in addition, the security cloud server 114 and/or the gateway 112, using the video verification device 151, can manage, process, and/or analyze such media data with or without communicating with the media analysis system 136.

The user controller 116 can be a remote device that is connected to the gateway 112. The user controller 116 provides a user interface for a user to interact with the home security system 100 including, for example, the existing security platform 120 (including the existing security control device 122 and/or the central monitoring station 124), the gateway 112, the security cloud server 114, and other security and automation devices. For example, the user controller 116 can be configured in the form of a touchpad having a touch screen that displays information about the home security system and provides virtual control elements (e.g., buttons, switches, etc.) to receive user inputs. In addition or alternatively, the user controller 116 can include a physical user interface, such as physical buttons, switches, etc., to receive user inputs.

The mobile computing device 118 can be a user's mobile device which can communicate with the security cloud server 114. The mobile computing device 118 provides a user interface for a user to interact with the security cloud server 114. For example, the mobile computing device 118 includes a touch screen that displays information about the home security system and provides virtual control elements (e.g., buttons, switches, etc.) to receive user inputs. In addition or alternatively, the mobile computing device 118 can include a physical user interface, such as physical buttons, switches, etc., to receive user inputs. The mobile computing device 118 can be connected to the security cloud server 114 via cellular networks 164. In addition or alternatively, the mobile computing device 118 can be connected to the security cloud server 114 over one or more IP networks 162 (e.g., Ethernet, Wi-Fi, and/or other IP networks). In addition or alternatively, the mobile computing device 118 can communicate with the security communicator device 112 directly, or via one or more networks (e.g., the communication networks 166). In addition or alternatively, the mobile computing device 118 can communicate with the existing security control device 122, the central monitoring station 124, and/or other security and automation devices directly, or via one or more networks (e.g., the communication networks 166).

In some implementations, the gateway 112 can include a translator 150 to facilitate communication with proprietary encrypted signals from devices (e.g., the sensors 128 and the peripheral devices 130) of the existing security platform 120.

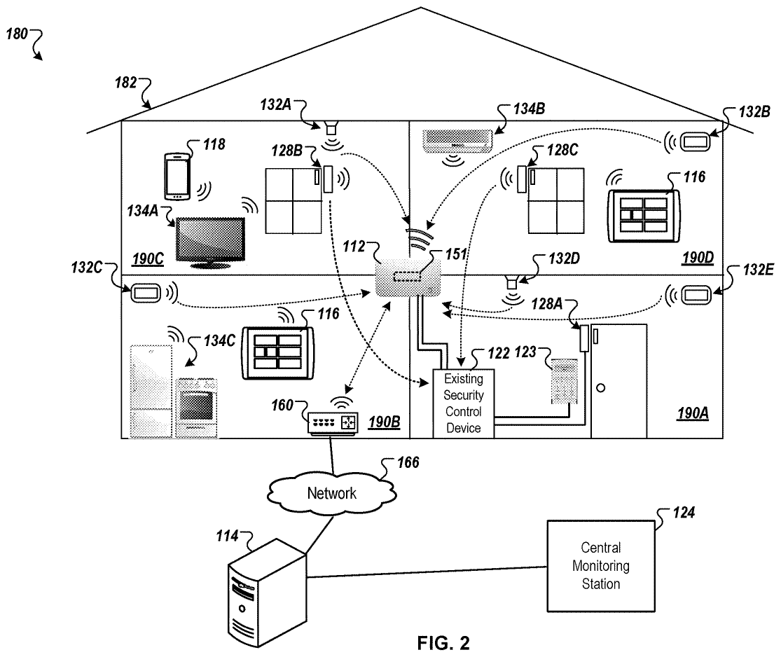

FIG. 2 is a diagram of an example environment 180 that can implement the system 100 of FIGS. 1A, 1B, and/or 1C. Premises 182 (e.g., a house, a facility, a store, a commercial space, another type of environment) may have a plurality of zones 190A-D (collectively 190), each of which includes sensors and devices (e.g. cameras) as part of the integrated home security and automation system. In the illustrated example, the zones 190 are defined by a plurality of rooms. Other ways to define multiple zones are also possible. Alternatively, the entire premises 182 can be controlled as a single zone.

In some implementations, each zone 190 may be monitored and controlled independently, such as in different schedules and/or settings, due at least part to different user settings and/or different groups of sensors and devices installed. By way of example, a first zone 190A is configured such that a door sensor is enabled between 7 PM to 6 AM every day and a room temperature is set 70° F., while a second zone 190B is configured such that a motion sensor is enabled between 10 PM to 5 AM Monday through Saturday and a room temperature is set 68° F. Alternatively, at least some of the zones 190 may be monitored and controlled in the same manner.

The zones 190 can include a mix of sensors and devices from the existing security platform 120 and from the security integration system 110. For example, the existing security control device 122 can include a door sensor 128A in a first zone 190A, a window sensor 128B in a third zone 190C, and a window sensor 128C in a fourth zone 190D. In this example, the door sensor 128A can be wired to and controlled through the existing security control device 122. For example, the door sensor 128A can be used to monitor the door opening and closing and transmit a door status signal (e.g., door open/close events) to the existing security control device 122 so that the existing security control device 122 determines whether to generate an alarm signal. In some implementations, the door sensor 128A may be armed or disarmed by a user who can controls the control panel 123. The window sensors 128B and 128C in the third and fourth zones 190C and 190D can be wirelessly connected and controlled by the existing security control device 122. The window sensors 128B and 128C are used to monitor the window opening and closing and transmit window status signals (e.g., window open/close events) to the existing security control device 122 so that the existing security control device 122 determines whether to generate an alarm signal. The control panel 123 can be used by a user to arm or disarm the window sensors 128B and 128C.

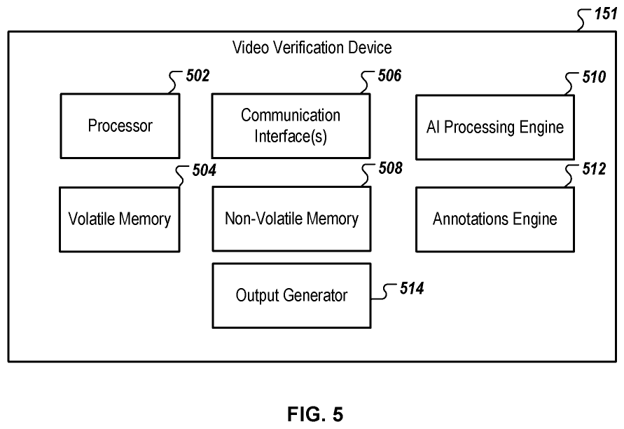

As described herein, the security integration system 110 provides the gateway 112 having the video verification device 151 that is connected to the existing security control device 122 to integrate and take over the existing security platform 120. In some implementations, as described with respect to at least FIG. 1B, the video verification device 151 can be part of the security integration system 110 but separate from the gateway 112. In addition, the premises 182 can be provided with additional security sensors, automation devices, and other components (e.g., the peripheral devices 130) that are connected to the gateway 112. For example, a smoke/air sensor 132D and a motion sensor 132E are installed in the first zone 190A and wirelessly connected to the security communicator device 112. A motion sensor 132C and kitchen equipment 134C disposed in the second zone 190B are wirelessly connected to the gateway 112. A smoke/air sensor 132A, a television 134A, and a mobile device 118 which are disposed in the third zone 190C are wirelessly connected to the gateway 112. A motion sensor 132B, an air conditioner 134B, and a user controller 116 (e.g., a touchpad) arranged in the fourth zone 190D are wirelessly connected to the gateway 112. As another illustrative example, one or more of the sensors 132 can include cameras that are wirelessly connected or otherwise communicating over one or more network connections to the gateway 112, and more specifically to the video verification device 151. The video verification device 151 can perform the techniques described in reference to at least FIGS. 3 and 5 on data received from at least the sensors 132 and on the edge. As described herein, the security integration system 110 including the gateway 112 and the security cloud server 114 operates to centrally manage and control all the sensors, devices, and components that are connected to the existing security control device 122 and the gateway 112.

FIG. 3 is a conceptual diagram of a system 300 for processing signals, such as video data, on the edge at the video verification device 151. In the system 300, the video verification device 151 can communicate over one or more network connections 301 and 303 and the network(s) 162 with the existing security platform 120, the peripheral devices 130 including but not limited to the security sensors 132 and cameras 153, and the security cloud server 114.

The video verification device 151 can be configured to receive signals (block A, 302) via the network connection 301 from the existing security platform 120 and its components, the peripheral devices 130 including the security sensors 132 and/or the cameras 153, and/or any combination thereof. The device 151 can be configured to continuously receive the signals. For example, many open protocols can be used that transport data through different ports. When the signals are generated, instead of rerouting the signals directly to the security cloud server 114, the signals can be redirected using port forwarding. For example, incoming signals such as video data can be rerouted through the network connection 301 to the video verification device 151. In this process, port forwarding helps guide the signals to a specific port of the video verification device 151. This setup can enable the video verification device 151 to efficiently handle the signals on the edge, without those signals getting lost or sent to a wrong location in the system 100.

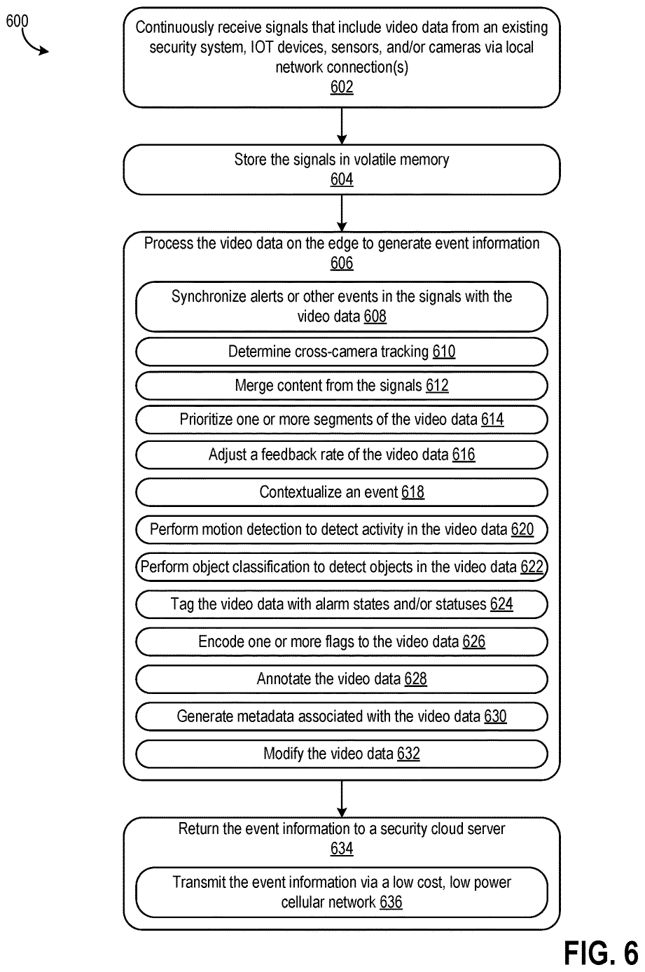

The device 151 can process the signals with AI techniques in block B (304). The processing can be performed on the edge at the device 151 with edge-deployed AI. The processing can be performed continuously, as the signals are received. Sometimes, the processing can be performed after a predetermined batch of signals is received and/or at predetermined time intervals. Refer to FIG. 6 for further discussion about the processing being performed on the signals.

The device 151 can also annotate the signals based on the processing in block C (306). Sometimes, the annotations can be made using AI techniques that are deployed on the edge at the device 151. Refer to FIG. 6 for further discussion about annotating the signals.

In traditional security systems, as camera or other video streams are generated, they are transmitted nonstop up to the security cloud server 114 or other relevant/associated devices in the system 300. This can result in lags in processing the video streams both efficiently and accurately. The disclosed system 300, on the other hand, provides for minimizing how much data is sent to the security cloud sever 114 by processing the video streams on the edge at the device 151. With edge processing, the device 151 can generate accurate information quickly, such as annotations of what appears in the video streams or other sensor data, relevant security panel information, alert statuses and/or signals, and/or other information that may be beneficial for understanding and contextualizing security events or other events more generally.

As a result of performing the signal processing and annotating with the AI at the edge (blocks B and C, 304 and 306 respectively), the video verification device 151 can prune and identify only relevant contextualized information to send to the security cloud server 114. Video data is typically large and can consume a significant amount of bandwidth when transmitted over network connections. By processing the video at the edge (e.g., at the video verification device 151), only relevant, contextualized information about security events is sent to the server 114. This can help reduce the amount of raw video data that needs to be transmitted, thereby lowering network load and avoiding potential congestion or high costs associated with data transfer. Said edge processing also provides for faster analysis of the video data since the processing occurs locally, on the device 151 itself, rather than waiting for the data to travel to the server 114 and back. This can result in lower latency, which can be critical for real-time security applications where timely responses to security events (e.g., identifying intruders or anomalies) may be necessary. Edge processing with AI allows the device 151 to analyze video footage and identify relevant events (e.g., security breaches) in context, using annotations, tags, and/or flags. Instead of sending large volumes of raw, unprocessed video, the device 151 can succinctly and quickly identify and send only the most relevant contextualized data to the server 114. This can reduce noise in the overall system 300, ensuring that cloud-based security teams or automated systems only receive actionable data that may be tied to security events.

By processing and filtering the data at the edge, sensitive video footage (e.g., surveillance recordings) also may not be transmitted over various networks to the server 114. This can help reduce risk of exposing private or sensitive information to potential security breaches during transmission. Instead, only processed, non-sensitive data about security events may be sent to the server 114, thereby improving overall data privacy and security. Moreover, sometimes the security cloud server 114 may become overwhelmed by the sheer volume of data, especially when dealing with video streams. By sending only curated and relevant data related to specific security events or alerts to the server 114, the video verification device 151 can focus on processing and analyzing more critical information, thereby allowing cloud resources to be used more efficiently and for different tasks/operations. This can make cloud storage and computing more cost-effective and scalable.

Accordingly, once the signals are processed and/or annotated, the video verification device 151 can transmit associated information via the network connection 303 and the network(s) 162 to the security cloud server 114 (block D, 308). The associated information may include portions of the video data with contextual information, annotations, metadata, etc. In some implementations, the device 151 can transmit the relevant video data as 1 frame per second. High or lower video content can also be provided based on network and/or security system configurations. In some implementations, AI techniques described herein can also be applied to the relevant video data to prioritize one or more video clips and/or adjust feedback rate depending on metadata associated with the relevant video data.

In some implementations, code executing at a camera and/or at the video verification device 151 can automatically adjust a resolution of a video stream based on a type of client device requesting access to the video stream, a type of request, and/or a current use case for the video stream. For example, when a request is associated with live situational awareness, alarm verification, bandwidth-constrained transmission, mobile presentation, and/or transmission over a low cost or low power network connection, the camera can provide a lower-resolution version of the video stream. By contrast, when a request is associated with forensic review, evidentiary capture, operator review, and/or another use case in which greater image detail may be beneficial, the camera can provide a higher-definition version of the video stream. In some implementations, the camera can automatically switch between the higher-definition and lower-resolution video streams without requiring manual reconfiguration by an installer or end user. As a result, the disclosed technology can tailor video delivery to different clients while reducing bandwidth consumption and preserving higher-detail video when appropriate.

The network connection 303 can be a low latency connection, such as a low-bandwidth cellular connection (CAT-M). The network connection 303 can be different than the network connection 301, which can provide additional layers of security to the overall system 300 and transmission of data between system components. The cellular connection 303 used to send the processed data to the server 114 can be optimized for low-latency communication, which can be crucial for ensuring quick transmission of important security events or insights. Since the data sent to the server 114 is already processed and curated (e.g., a security alert or event summary), it is much smaller in size, thereby requiring less bandwidth. A low-bandwidth cellular connection can therefore be preferred for transmitting these small, high-priority data packets efficiently. By using the separate connections 301 and 303, the system 300 can ensure that the data transfer for the incoming video streams and the outgoing processed data does not compete for same network resources. If both data types were sent over a single connection, for example, the network(s) 162 can become congested, leading to delays in receiving the video signals or issues with sending processed data in a timely manner. Separating the traffic allows each connection to function independently and more efficiently.

Using the separate network connections 301 and 303 also provides improved reliability. If one network connection (such as the high-bandwidth connection 301 for receiving video data) experiences issues or disruptions, it does not impact the transmission of processed data to the server 114 (via the low-latency, low-bandwidth cellular connection 303). This redundancy ensures that security events or alerts can still reach the server 114 even if the video data stream faces temporary issues. Moreover, cellular networks typically have limited bandwidth compared to wired networks. By sending only the processed, relevant data (such as security alerts or event logs) over the cellular connection 303, the disclosed system 300 can make best use of available bandwidth. Video streams, on the other hand, are large and can overwhelm a cellular network if transmitted in real-time, so they can be handled by the primary connection 301 instead. This ensures that the cellular network connection 303 is used efficiently without overloading it. The low-latency, low-bandwidth cellular connection 303 also ensures that the processed data is transmitted to server 114 cloud quickly. This can be crucial in applications like security, where real-time event reporting may sometimes be essential. Whether it's a security alert or a detected anomaly, the faster the processed data reaches the server 114, the quicker the overall system 300 may respond, making the system 300 more responsive and effective.

The security cloud server 114 can be configured to optionally perform additional processing based on the transmitted information (block E, 310). Additionally or alternatively, the security cloud server 114 can return at least a portion of the information to relevant user devices using one or more other secure network connections (block F, 312). For example, the server 114 can transmit alert statuses or other relevant information that was identified and/or annotated by the device 151 to emergency response team devices, monitoring stations, etc.

In some implementations, the video verification device 151 can be configured to transmit the information in block D (308) directly to devices of the emergency response teams, monitoring stations, or other relevant users (instead of passing through the security cloud server 114). The device 151 can transmit said information using one or more other network connections. Sometimes, the device 151 can transmit the information using the connection 303 or another type of low latency low bandwidth network connection that is different from at least the network connection 301.

Information that is presented at the devices of the emergency response teams, monitoring stations, or the other relevant users can include but is not limited to video snippets or feeds that are associated with one or more alarm conditions and relevant information from processing the video data in association with the alarm conditions. Sometimes, the video snippets or feeds can be presented with restricted access, limited time availability. Sometimes, the video snippets can be presented in addition to live views from any one or more of the cameras 153 that the relevant users are authorized to access on the premises.

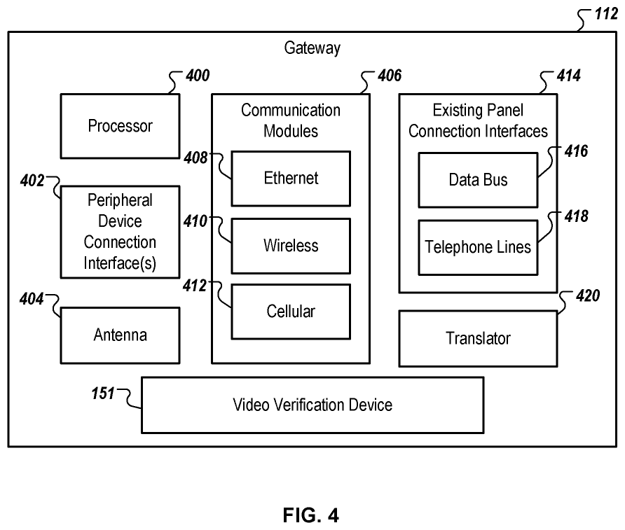

FIG. 4 is a diagram of an example gateway 112, or security communicator device, that can be configured to provide an integrated home security and automation service with a video verification device 151. The gateway 112 can be used to at least partially implement techniques described herein. The gateway 112 can include a processor 400, a plurality of communication modules 406, one or more existing panel connection interfaces 414, one or more peripheral device connection interfaces 402, an antenna 404, a translator 420, and/or the video verification device 151.

The plurality of communication modules 406 can include an Ethernet port 408, a wireless communication module 410 (e.g., Wi-Fi, Bluetooth, NFC, and/or other suitable wireless protocols), a cellular communication module 412, and/or any combination thereof.

The existing panel connection interfaces 414 can be connected to existing control panels. Depending on the type of an existing control panel to be connected, one of the interfaces 414 can be selected and connected to the existing control panel. The existing panel connection interfaces 414 can a data bus interface 416 (e.g., a RS485 connector), a phone line interface 418, and other data communication interfaces compatible with various types of existing control panels.

The peripheral device connection interfaces 402 can be used to connect peripheral devices (e.g., the peripheral devices 130 including the security sensors 132 and the home automation device 134). The peripheral device connection interfaces 402 can include interfaces of various wired or wireless protocols, such as Ethernet, Wi-Fi, Bluetooth, NFC, cellular, etc. The peripheral device connection interfaces 402 can share hardware and software modules with the existing panel connection interfaces 414. The peripheral device connection interfaces 402 enables peripheral devices to be enrolled into an existing control panel to which the gateway 112 is connected via one or more of the existing panel connection interfaces 414. In addition or alternatively, peripheral devices can communicate with a cloud platform (e.g., the security cloud server 114) either directly, or through the gateway 112 to which the peripheral devices are connected via one or more of the peripheral device connection interfaces 402, so that the premise is monitored by the cloud platform and/or the security communicator device independent of the security offerings from the existing control panel. This can allow users having their existing security systems upgraded to include the gateway 112 to add sensors or other peripheral devices that can be used without triggering alarms on the existing security platform. Accordingly, the gateway 112 can support an ability to add both panel monitored and/or cloud monitored sensors to these legacy systems via the existing panel connection interfaces 414. The gateway 112 can optionally include one or more internal options to enhance the processor 400, such as an automation hardware chipset/module that is optimized to communicate with and/or process automation-based information and/or a translator receiver chipset/module that is optimized to receive translator communication.

The gateway 112 can further include the translator 420 configured to translate protocol between the gateway 112 and an existing security platform to which the gateway 112 is connected. The translator 420 can be configured to provide universal translation between a variety of different protocols of different devices.

As described in reference to at least FIG. 1A, the gateway 112 can include the video verification device 151, which can be configured to receive signals from other devices, such as the peripheral devices, and process the signals on the edge to generate relevant, contextualized data. The video verification device 151 can be configured to run on the processor 400, using the communication modules 406 (e.g., the wireless communication module 410). As a result, the device 151 can connect with an existing security system/platform and/or any other relevant or related devices, sensors, and/or systems.

For example, the video verification device 151 can receive video feeds, streams, or other data from the sensors and other devices. The device 151 can apply AI techniques to the received video data to process the data. As part of processing the video data, the device 151 can generate contextualized data such as annotations, modifications, and/or metadata associated with particular security events, other types of events, alert statuses, and/or alert states. Refer to at least FIGS. 3 and 5 for further discussion about operations performed by the video verification device 151.

FIG. 5 is a diagram of the example video verification device 151 described herein. The device 151 can include one or more processors 502, volatile memory 504, communication interfaces 506, non-volatile memory 508, an AI processing engine 510, an annotations engine 512, an output generator 514, and/or any combination thereof. In some implementations, the volatile memory 504 and/or the non-volatile memory 508 can be a same memory or type of storage. In brief, the processor(s) 504 can be configured to execute instructions stored in the memory 504 and/or 508 to perform the disclosed techniques on the edge (e.g., processing video data to contextualize the data and/or generate relevant information for the security cloud server 114). The communication interface(s) 506 can be similar to those described with respect to the gateway 112 in FIG. 4.

The volatile memory 504 can be configured to store video data and other signals that are continuously received from peripheral devices, cameras, and/or other sensor devices in the premises (e.g., a home, a building). The memory 504 can act as a buffer, temporarily holding the incoming video and sensor data before it is processed locally, on the edge at the device 151 or sent to other system components (e.g., the security cloud server 114). As data comes in, the buffer of the memory 504 may overwrite the oldest data, ensuring that the most recent signals are retained. This approach allows for real-time data handling without overwhelming the device 151 with excessive storage requirements. While the volatile memory 504 can be used for temporary storage, it can include a battery backup, ensuring that data remains available during any potential power interruptions. In certain cases, the device 151 can also write this data to the non-volatile memory 508, which can include but is not limited to SD cards, solid state drives (SSDs), hard disk drives (HDDs), flash memory, etc., thereby providing additional reliability. In some implementations, the non-volatile memory 504 can be configured to store the video data and the other signals as described above with respect to the volatile memory 504. In yet some implementations, other types of storage structures can be used to store the data as described herein.

The AI processing engine 510 can be configured to perform edge processing operations at the video verification device 151 to glean contextualized information about security events and other types of events in video data. Refer to FIG. 6 for further discussion about edge processing operations that may be performed by the engine 510.

The annotations engine 512 can be configured to annotate and/or modify portions of the video data based on the processing performed by the engine 510. For example, the engine 512 can be configured to annotate portions of the video data that correspond to the occurrence of an alarm condition or another triggering condition. Sometimes, the annotations engine 512 may be configured to generate metadata based on the processing performed by the engine 510. The engine 512 can be configured to implement one or more AI techniques described herein to annotate the video data. In some implementations, the annotations engine 512 can be the same as or otherwise part of the AI processing engine 510.

The output generator 514 can be configured to generate information, based on the processing performed by the engine 510 and the annotations generated by the engine 512, to be transmitted to other devices and systems (e.g., the security cloud server 114, devices of relevant users, emergency responders, monitoring stations). For example, the output generator 514 can generate a packet of information to be sent to the security cloud server 114, which can include contextual information generated by the engine 510, one or more video clips or snips that are relevant to a detected emergency or other event, associated metadata, and/or associated annotations. Sometimes, the generator 514 can also generate instructions for presenting any portion of the information at another device or system, such as the device of a relevant user, emergency responder, and/or monitoring station. The generator 514 can be configured to transmit the information to the other devices and/or systems described herein using one or more network connections (e.g., low latency, low bandwidth network connections).

FIG. 6 is a flowchart of a process 600 for processing signals, such as video data, on the edge with AI techniques. The process 600 can be performed by components of the video verification device 151 described herein. The process 600 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 600 is described from the perspective of a video verification device.

Referring to the process 600, the video verification device can continuously receive signals that include video data from an existing security system, IOT devices, sensors, and/or cameras via local network connections (block 602).

In block 604, the video verification device can store the signals in volatile memory. Refer to FIG. 5 for further discussion about temporarily storing the signals and overwriting oldest signals as additional, new signals are received.

The video verification device can also process the video data on the edge to generate event information in block 606. The device can generate the event information by linking or otherwise associating the video data with security events or other types of events, as described further below. For example, the device can associate portions of the video data with different types of events, including intrusions, fire detections, and/or smoke detections on premises. The device can use edge AI techniques to process the video data. The AI can be trained at a remote system (e.g., the security cloud server 114) then compressed and deployed on the edge at the device for runtime use. The edge processing, as described herein, can provide advantages in reducing network bandwidth constraints and improving efficiency in use of available compute resources.

The processing can include synchronizing alerts or other events in the signals with the video data (block 608). The device can leverage AI techniques to automatically correlate alarm conditions in the received signals with specific segments of the video data. The device can be in continuous network communication with other security system components, such as intrusion panels, motion detectors, and door/window sensors. Accordingly, this interconnected setup allows for detecting and triggering of an alarm condition when specific thresholds are met to be associated with particular segments of the video data. AI-powered algorithms, such as object detection and/or event recognition, can be used to identify critical moments in the video data that align with the triggered alarm condition(s). For example, if an intrusion panel detects unauthorized access through a door, the device can immediately associate this alarm with video footage from a nearby camera (e.g., based on knowing locations of devices throughout the premises and timestamps of signals captured by those devices located proximate each other). Using the AI, the device can identify key frames or segments in the video data that capture the moment of intrusion. The AI can be used to ensure that the device matches a time and location of the security event with visual evidence alongside the alert.

The processing can include determining cross-camera tracking in block 610. For example, the device can leverage AI techniques on the edge to enhance the ability to monitor and analyze movements across multiple areas within a premises. By utilizing object detection, tracking algorithms, and/or machine learning models, the device can track movement of individuals, vehicles, or other relevant objects as they transition between different camera views in real-time. When an object enters a field of view of one camera, for example, the AI deployed on the edge can identify it and then maintain its identity as it moves across multiple camera feeds. The device may continuously update its understanding of the object's position, speed, and trajectory, thereby correlating information from each camera's video feed to maintain a unified, accurate tracking path across an area or the premises. Sometimes, the AI can be trained to flag unusual or suspicious movement patterns that may span multiple camera views, such as a person moving through restricted areas or repeatedly circling the premises, alerting security teams in real-time. By processing this data locally on the device, cross-camera tracking can be performed quickly and efficiently, without the need for constant communication with remote systems such as the cloud server, thereby ensuring low latency and high responsiveness.

The processing can include merging content from the signals (block 612). By processing both video and sensor data locally, the device can apply machine learning models, such as AI, to identify significant patterns and correlations in real-time. For example, if motion sensors detect movement in a specific area, the AI can be trained to cross-reference this with the video data from nearby cameras to confirm presence of a person or object. The device can then combine this visual information with data from other sources, such as temperature sensors (e.g., detecting a potential fire), audio sensors (e.g., detecting glass breaking), and/or alarm systems (e.g., triggered by unauthorized access) to provide contextualized data about an event at the premises.

The processing can include prioritizing one or more segments of the video data (block 614). The AI can be trained to identify segments of the video data that are most relevant to a particular event, signals, and/or alarm condition.

The processing can include adjusting a feedback rate of the video data (block 616). The device can use AI techniques to dynamically adjust the feedback rate of the video data that will be transmitted to other systems, such as the security cloud server based on real-time analysis of a scene, optimizing the device's responsiveness and resource usage. By applying machine learning models at the edge, the device can continuously analyze a video feed and surrounding context to determine when and how much video data needs to be sent for processing or transmitted to the cloud.

The processing can include contextualizing an event (block 618). AI techniques can be implemented by the device to determine context of the event. The context of the event can be determined based on identifying associations between and mapping the different signals that are received and processed by the device.

The processing can include performing motion detection techniques to detect activity in the video data (block 620). AI models, such as convolutional neural networks (CNNs) and/or other deep learning architectures, can be trained to detect different types of changes in video frames. These models can identify movement and/or specific activities by analyzing differences between consecutive frames and/or recognizing predefined patterns of motion. Once motion is detected, the AI can further be trained to analyze a scene and identify relevant activities based on predetermined criteria and/or event recognition techniques and rulesets. Portions of the video data that include the detected motion and/or activities can be transmitted, as described herein, up to cloud systems, such as the security cloud server 114 to reduce bandwidth and latency. In some implementations, the cloud systems can be configured to receive and store the relevant video snippets, where additional processing such as long-term analysis, alerting, and/or data aggregation may occur. The motion detection techniques described herein can be performed as part of the processing in any one or more of blocks 606-632.

The processing can include performing object classification to detect objects in the video data (block 622). AI models with deep learning architectures can be used to classify objects in each frame, groups of video frames, and/or selected/particular frames. These models can be trained on large datasets to recognize various different types of objects (e.g., people, vehicles, animals, etc.) by analyzing patterns, shapes, and textures in the image. An AI model can, for example, processes each video frame, detecting and classifying objects present in the scene. The AI assigns labels to the objects (e.g., apply annotations and/or generate metadata) and may also provide bounding boxes around those identified objects for spatial localization within the frame. Therefore, the device performs the classification locally, identifying and tagging the objects within the video data without needing to send the entire video to the cloud system. The object classification techniques described herein can be performed as part of the processing in any one or more of blocks 606-632.

The processing can include tagging the video data with alarm states and/or statuses (block 624). The motion detection and/or object detection techniques described above can be used to detect specific objects and/or people in the video frames. The AI techniques can also be used to identify and classify the objects and then tag those objects with relevant information (e.g., “person,” “car,” “suspicious object”). The AI techniques can also detect motion, activity patterns, and/or events, thereby distinguishing between normal and abnormal behavior. As the AI detects the events and/or objects, the AI can also tag portions of the video frames with relevant information, such as alert states and/or statuses. For example, the AI can tag a video frame with “motion detected” where motion is detected in a particular location on the premises. As another example, the AI can tag a video frame with “suspicious activity” if abnormal behaviors, such as an unknown person lingering in an area on the premises for an extended period of time, are recognized.

The processing can include encoding one or more flags to the video data (block 626). To reduce bandwidth usage and increase processing efficiency, encoding flats (e.g., keyframes) can be used. Instead of sending full video streams to other systems, such as the security cloud server 114, the device can selectively encode only key frames or relevant portions of video, along with metadata (e.g., tags, labels, alarm states, classifications). Therefore, instead of transmitting every frame, the device may send only every nth frame or the most informative frames that contain relevant activity (e.g., an intruder entering a restricted area). With respect to delta encoding, only differences (or deltas) between consecutive frames may be transmitted in some implementations, rather than sending full frames. This technique can significantly reduce data transmission size. Sometimes, metadata embedding may be used, in which alarm states, event conditions, and/or other alarm statuses may be encoded directly into the metadata of the video frames, so that video content and its corresponding event/alert information are tightly coupled. In some implementations, the device can encode the video using compression algorithms including but not limited to H.264, H.265 (HEVC), and/or other codecs optimized for efficient video transmission. These codecs can reduce the size of the video without compromising quality, thereby allowing for more efficient bandwidth usage. For example, intra-frame compression can be used in which key frames may be encoded with high quality, while subsequent frames use lower-quality encoding to store the differences between the frames. Reduced frame rate techniques may also be used, where if certain periods of the frames are less active, the device can reduce the corresponding video frame rate, thereby decreasing data size. Alarm state tags along with compressed video and/or relevant metadata (e.g., “Intruder detected” and a relevant timestamp) may be encoded into a transmission packet for cloud and/or remote system analysis.

The processing can include annotating the video data accordingly (block 628). The annotations can be applied to the video data based on one or more of the blocks 606-626 being performed. For example, the device can detect objects in the video data, label those objects, and generate confidence scores representing certainty about the object detections. The device can also generate annotations that include timestamps marking when particular events or activities are detected to keep tracking of timing aspects. Annotations can also be applied to start and end times of detected events/activities for event duration and tracking. Annotations can also be applied to the video data showing changes in motion, to indicate where and when movement occurred. Movement paths of detected objects across the video frames may also be annotated, thereby marking a trajectory of a person or object.

The processing can include generating metadata associated with the video data (block 630). The metadata can be applied based on one or more of the blocks 606-626 being performed. The device can embed tags directly into the video data and/or as metadata alongside the video data, thereby reducing need for separate transmissions. Timestamps and/or event labels can be logged in the metadata accompanying the video data. Sometimes, compressed video data can be tagged with object metadata to ensure that relevant frames are transmitted and/or stored. For further bandwidth reduction, the device can send low-resolution video (e.g., 720p) while keeping high-quality metadata (e.g., alarm state, object details) intact, allowing security personnel to quickly review the situation with minimal data transfer. Sometimes, the metadata can include but is not limited to labels for objects, such as their type, size, position, and/or time of detection. Alarm states and/or statuses can be generated into metadata, including but not limited to type of event, location, time, and/or severity information. Movement tracking information can be generated into metadata, including information about each detected change in position and/or direction. In some implementations, the device can generate time-series metadata logs, which can record significant events along with their timestamps. This log can be synchronized with the video and/or independently stored for future use and analysis. Sometimes, the metadata can be embedded directly into the video stream and/or as part of the encoded video. This can allow for both the video and the metadata to be transmitted together, thereby reducing complexity of handling separate files. Even when the video is compressed, the metadata can be preserved at the frame level, therefore relevant information can be easily retrieved during analysis without sending full-resolution videos.

The processing can include modifying the video data (block 632). In some implementations, modifying the video data can include compressing the video and/or encoding the video, as described above. Modifying the video data can include overlaying annotations and/or metadata directly onto the video frames. Modifying the video data may include extracting and retaining key frames that contain relevant information about events, such as detection of objects and/or movement. As a result, the device can reduce the video size and amount of data being transmitted to other systems, such as the security cloud server 114. In some implementations, the device can apply motion blurring to the video data. If an area in the video shows no significant events, the device can apply motion blurring to reduce the clarity of less important frames. For example, if there's just a background with no activity, it can be blurred to focus on areas where there is more action or interest. Sometimes, parts of the video may be irrelevant (e.g., a wall or area with no activity). So, the device can mask those regions by modifying the video (e.g., blurring, blacking out). Similarly, the device can modify the video data by cropping the video around objects of interest and/or dynamically zooming into the objects of interest. In yet some implementations, the device can modify the video data by segmenting it into smaller clips based on detected events (e.g., a motion detection event, a person entering a restricted area). These segments can be stored or transmitted as individual clips rather than as a continuous video stream. One or more other modifications may also be performed on the video data based on performing any one or more of blocks 606-630.

Based on the processing, the video verification device can return the event information to a security cloud server in block 634 (e.g., the security cloud server 114). This information may include critical metadata, such as detected events (e.g., motion, object detection, intrusion alerts), the type of objects detected (e.g., people, vehicles, animals), and/or any associated status or alarm states (e.g., unauthorized access, suspicious behavior, or security breach). The event information can include relevant timestamps, locations, and confidence levels for each detection, allowing for a clear, structured understanding of the event.

The video verification device can transmit the event information via a low cost, low power cellular network (block 636). The event information can also be transmitted by other networks, such as high cost and/or high power cellular networks. To ensure efficient data transmission, the video verification device may transmit relevant snippets of the processed video, focusing on key frames or short video segments that capture the critical moments of an event. By selectively compressing and segmenting the video data, the device can minimize the data payload sent to the cloud. Additionally, the metadata can be embedded within the video stream itself, ensuring that the event details are transmitted alongside the video content. The use of low cost, low power cellular networks can help maintain cost-effective operations without sacrificing timeliness or accuracy of security event reporting. The data transmission can be optimized using techniques such as compression, selective frame transmission, and/or metadata embedding, all of which reduce the overall bandwidth usage while ensuring that the cloud server receives the most relevant information. The low cost, low power cellular network can include but is not limited to long-term evolution (LTE), fifth generation (5G), and/or narrowband Internet of Things (NB-IoT). One or more other network connections described herein can be used, including but not limited to high cost and/or high power cellular networks.

The security cloud server can process this incoming event data, log it for historical analysis or other further analyses, and may trigger appropriate responses, such as sending alerts to security personnel or activating automated security measures (e.g., locking doors, triggering alarms). By processing the data at the edge and selectively transmitting information to the cloud, the disclosed technology can ensure that bandwidth usage is minimized, response times are fast, and overall security system is both efficient and scalable.

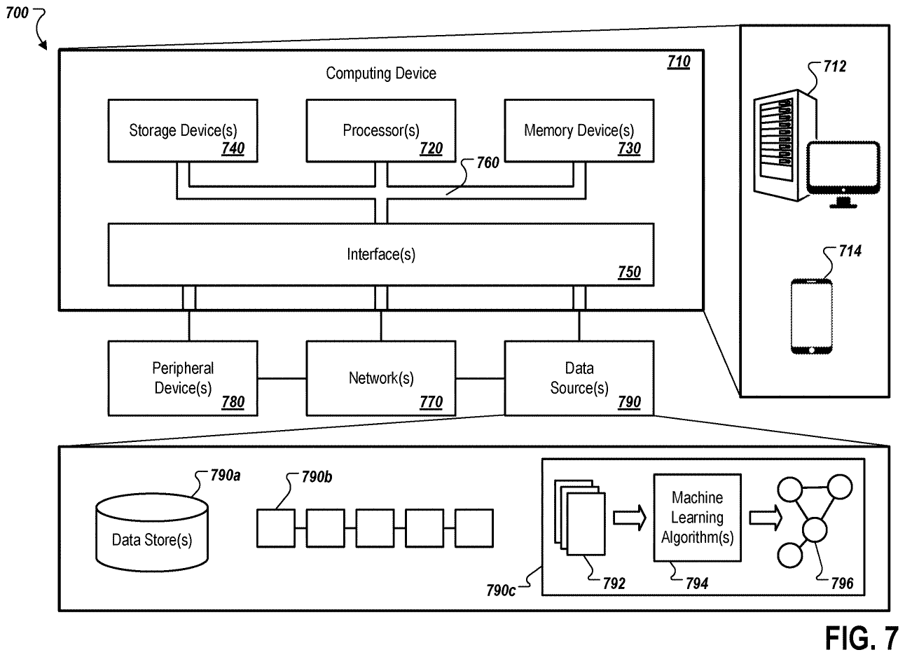

FIG. 7 is a schematic diagram that shows an example of a computing system 700 that can be used to implement the techniques described herein. The computing system 700 includes one or more computing devices (e.g., computing device 710), which can be in wired and/or wireless communication with various peripheral device(s) 780, data source(s) 790, and/or other computing devices (e.g., over network(s) 770). The computing device 710 can represent various forms of stationary computers 712 (e.g., workstations, kiosks, servers, mainframes, edge computing devices, quantum computers, etc.) and mobile computers 714 (e.g., laptops, tablets, mobile phones, personal digital assistants, wearable devices, etc.). In some implementations, the computing device 710 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 710, and an entire system can be made up of multiple devices communicating with each other. For example, the computing device 710 can be part of a computing system that includes a network of computing devices, such as a cloud-based computing system, a computing system in an internal network, or a computing system in another sort of shared network. Processors of the computing device (710) and other computing devices of a computing system can be optimized for different types of operations, secure computing tasks, etc. The components shown herein, and their functions, are meant to be examples, and are not meant to limit implementations of the technology described and/or claimed in this document.

The computing device 710 includes processor(s) 720, memory device(s) 730, storage device(s) 740, and interface(s) 750. Each of the processor(s) 720, the memory device(s) 730, the storage device(s) 740, and the interface(s) 750 are interconnected using a system bus 760. The processor(s) 720 are capable of processing instructions for execution within the computing device 710, and can include one or more single-threaded and/or multi-threaded processors. The processor(s) 720 are capable of processing instructions stored in the memory device(s) 730 and/or on the storage device(s) 740. The memory device(s) 730 can store data within the computing device 710, and can include one or more computer-readable media, volatile memory units, and/or non-volatile memory units. The storage device(s) 740 can provide mass storage for the computing device 710, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 750 can include various communications interfaces (e.g., USB, Near-Field Communication (NFC), Bluetooth, WiFi, Ethernet, wireless Ethernet, etc.) that can be coupled to the network(s) 770, peripheral device(s) 780, and/or data source(s) 790 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 750 can include a control interface that receives commands from an input device (e.g., operated by a user) and converts the commands for submission to the processors 720. The interface(s) 750 can include a display interface that includes circuitry for driving a display to present visual information to a user. The interface(s) 750 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 770 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 710 can communicate with the peripheral device(s) 780, the data source(s) 790, and/or other computing devices over the network(s) 770. In some implementations, the computing device 710 can directly communicate with the peripheral device(s) 780, the data source(s), and/or other computing devices.

The peripheral device(s) 780 can provide input/output operations for the computing device 710. Input devices (e.g., keyboards, pointing devices, touchscreens, microphones, cameras, scanners, sensors, etc.) can provide input to the computing device 710 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 710 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 790 can provide data for use by the computing device 710, and/or can maintain data that has been generated by the computing device 710 and/or other devices (e.g., data collected from sensor devices, data aggregated from various different data repositories, etc.). In some implementations, one or more data sources can be hosted by the computing device 710 (e.g., using the storage device(s) 740). In some implementations, one or more data sources can be hosted by a different computing device. Data can be provided by the data source(s) 790 in response to a request for data from the computing device 710 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 790a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 790b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 790c. The machine learning system(s) 790c, for example, can be used to analyze data from various sources (e.g., data provided by the computing device 710, data from the data store(s) 790a, data from the blockchain(s) 790b, and/or data from other data sources), to identify patterns in the data, and to draw inferences from the data patterns. In general, training data 792 can be provided to one or more machine learning algorithms 794, and the machine learning algorithm(s) can generate a machine learning model 796. Execution of the machine learning algorithm(s) can be performed by the computing device 710, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for edge video verification, the system comprising:
a security cloud server; and
a video verification device configured to communicate with the security cloud server via one or more networks and further configured to perform operations comprising:
receiving video data from peripheral devices on a premises;
processing the video data on the edge to generate event information; and
returning the event information to the security cloud server over the one or more networks.

2. The system of claim 1, wherein the peripheral devices include video cameras.

3. The system of claim 2, wherein at least one of the video cameras is a battery-backed camera configured to continue capturing video data during a power interruption.

4. The system of claim 2, wherein at least one of the video cameras is configured to adjust a resolution of the video data based on at least one of a type of client device requesting the video data or available network bandwidth.

5. The system of claim 1, wherein the one or more networks include low cost, low power cellular networks.

6. The system of claim 1, wherein the video data is received from the peripheral devices over another network, wherein the another network is different than the one or more networks.

7. The system of claim 1, wherein the system further comprises a gateway configured to communicate with the security cloud server and the video verification device via the one or more networks, the gateway device configured to be connected to an existing security panel at the premises.

8. The system of claim 7, wherein the video verification device is part of the gateway.

9. The system of claim 1, wherein processing the video data on the edge includes applying artificial intelligence (AI) techniques to the video data.

10. The system of claim 9, wherein the AI techniques were trained to tag the video data with alarm states and alarm statuses.

11. The system of claim 9, wherein the AI techniques were trained to encode one or more flags to the video data that correspond to at least one of detected activities, events, objects, and movements in the video data.

12. The system of claim 9, wherein the AI techniques were trained to annotate the video data based on detecting at least one of activities, events, objects, and movements in the video data.

13. The system of claim 9, wherein the AI techniques were trained to generate metadata for the video data based on detecting at least one of activities, events, objects, and movements in the video data.

14. The system of claim 1, wherein processing the video data on the edge to generate the event information includes associating the video data to a security event.

15. The system of claim 14, wherein the security event includes at least one of an intrusion on the premises, a fire at the premises, and smoke at the premises.

16. A method for edge video verification, the method comprising:
receiving video data from peripheral devices on a premises;
processing the video data on the edge to generate event information; and
returning the event information to a security cloud server over one or more networks.

17. The method of claim 16, wherein the peripheral devices include video cameras.

18. The system of claim 1, wherein processing the video data on the edge includes applying artificial intelligence (AI) techniques to the video data.

19. The system of claim 1, wherein processing the video data on the edge to generate the event information includes associating the video data to a security event.
